(19) United States
(12) Patent Application Publication
(10) Pub. No.: US 2007/0157979 A1
(43) Pub. Date: Jul. 12, 2007

(54) Fluid-control system

(75) Inventor: Mark Phillip Vonderwell, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/326,507

(22) Filed: Jan. 6, 2006

(51) Int. Cl. F15B 13/043

(52) U.S. Cl. 137/625.64

(57) ABSTRACT

A spool valve includes a valve housing. The valve housing may include a cavity, a first passage extending from the cavity, and a plurality of ports connected to the cavity. The spool valve may also include one or more components blocking the first passage, including a spool valve element disposed in a first position at least partially within the cavity. The spool valve element may be moveable to one or more other positions wherein the spool valve element leaves the first passage unblocked.

### TECHNICAL FIELD

The present disclosure relates to fluid-control systems and, more particularly, to fluid-control systems having one or more valve elements configured to control fluid flow through one or more passages.

### BACKGROUND

Many machines include fluid-control systems for controlling fluid flow through one or more passages. Such fluid-control systems generally include one or more moveable valve members and a structure with one or more passages. Each valve member is generally configured such that its position affects whether and/or at what rate fluid flows through one or more passages of the structure. Additionally, many fluid-control systems include valve controls for manually and/or automatically moving one or more of the valve members in order to control the flow of fluid through the passages of the structure.

Some fluid-control systems have configurations that allow some undesirable flow of fluid through one or more passages in the structure under some circumstances. For example, some spool valves have configurations that cause them to leak under some circumstances. Some spool valves have a valve housing with an elongated cavity and plurality of ports connected to the elongated cavity by various passages. Additionally, some valve housings of spool valves include an access passage extending from an opening in an end wall of the elongated cavity.

Spool valves often include a valve member moveably disposed at least partially inside the elongated cavity and a drive member for moving the valve member. In many configurations of spool valves, the valve member and drive member engage one another through the access passage. In such configurations of spool valves, the valve member extends through some or all of the access passage to meet the drive member and/or the drive member extends through some or all of the access passage to meet the valve member.

Some spool valves may be configured with one or more available operating states for preventing fluid flow from the elongated cavity through the access passage. In some such operating states, a portion of the valve member extends through the opening in the end wall of the elongated cavity into the access passage so as to impede fluid flow between the elongated cavity and the access passage. However, when a spool valve has such an operating state, the valve member leaves a portion of the opening between an outer surface of the valve member and the perimeter of the opening exposed. As a result, fluid may flow from the elongated cavity to the access passage by flowing between the outer surface of the valve member and the perimeter of the opening.

U.S. Pat. No. 6,792,975 to Erickson et al. (“the '975 patent”) shows a spool valve having a valve member configured to impede fluid flow between an elongated cavity and an access passage extending therefrom by sealing against an end wall of the elongated cavity. The spool valve of the '975 patent includes a valve housing having an elongated cavity and a plurality of ports, including a supply port, a control port, and an exhaust port, connected to the elongated cavity. The supply and control ports connect to the elongated cavity through openings in the sides of the elongated cavity. The exhaust port connects to the elongated cavity through an access passage that extends from an opening in a first end wall of the elongated cavity. A portion of the first end wall extending around the opening forms an annular sealing surface.

The valve member of the '975 patent is disposed primarily within the elongated cavity of the valve housing. The valve member engages side walls of the elongated cavity in a manner restricting movement of the valve member to sliding along the axis of the elongated cavity. The valve member includes an annular sealing ring configured to mate with the annular sealing surface extending around the opening in the first end wall. Additionally, the valve member of the '975 patent includes a valve stem configured to extend through the access passage when the annular sealing ring mates with the annular sealing surface extending around the opening in the first end wall. Furthermore, the valve member includes an internal passage extending from a first opening disposed inside the annular sealing ring of the valve member to a second opening at an opposite end of the valve member.

The spool valve of the '975 patent also includes valve controls that control fluid flow between the ports of the valve housing by moving the valve member along the axis of the elongated cavity. The valve controls of the '975 patent include a spring that urges the valve member toward the first end wall of the elongated cavity. Additionally, the valve controls include a controllable actuator that is operable to selectively engage the valve stem and drive the valve member toward a second end wall of the elongated cavity. Operating the controllable actuator to drive the valve member toward the second end wall of the elongated cavity separates the annular sealing ring from the first end wall. This allows fluid to flow from the elongated cavity to the access passage through spaces between the annular sealing ring and the first end wall of the elongated cavity. When the controllable actuator of the '975 patent does not oppose the spring, the spring drives the annular sealing ring against the first end wall of the cavity so that fluid in the elongated cavity cannot flow past the annular sealing ring into the access passage.

Although the spool valve of the '975 patent has a valve member configured to seal against the first end wall of the elongated cavity, certain disadvantages persist. For example, even with its annular sealing ring sealed against the first end wall of the elongated cavity, the first valve member does not block the flow of fluid between the elongated cavity and the access passage. When the annular sealing ring of the valve member is sealed against the first end wall of the elongated cavity, fluid may flow from the elongated cavity, through the internal passage in the valve member, to the access passage.

The fluid-control system of the present disclosure solves one or more of the problems set forth above.

### SUMMARY OF THE INVENTION

One disclosed embodiment relates to a spool valve that may have a valve housing. The valve housing may include a cavity, a first passage extending from the cavity, and a plurality of ports connected to the cavity. The spool valve may also include one or more components blocking the first passage, including a spool valve element disposed in a first position at least partially within the cavity. The spool valve element may be moveable to one or more other positions wherein the spool valve element leaves the first passage unblocked.

Another embodiment relates to a fluid-control system with a structure that includes a first passage between a first space and a second space. The fluid-control system may also include a plurality of components blocking the first passage. The plurality of components blocking the first passage may include a first valve element, wherein a second passage extends through the first valve element. The second passage may be configured to provide fluid communication between the first passage and the second space when the second passage is unblocked. The plurality of components blocking the first passage may also include one or more additional valve elements blocking the second passage. Additionally, the fluid-control system may include valve controls operable to selectively unblock the first passage by moving one or more of the additional valve elements to unblock the second passage and, subsequently, moving the first valve element.

A further disclosed embodiment relates to a method of operating a fluid-control system having a structure including a first passage disposed between a first space and a second space. The method may include blocking the first passage with a plurality of components, the plurality of components including a first valve element having a second passage extending therethrough and one or more additional valve elements blocking the second passage. Additionally, the method may include subsequently unblocking the first passage. Unblocking the first passage may include moving one or more of the additional valve elements to unblock the second passage and, thereby, provide fluid communication between the first passage and the second space through the second passage. Additionally, unblocking the first passage may include subsequently moving the first valve element.

Another disclosed embodiment relates to a valve. The valve may have a valve housing having a plurality of ports. The valve may also include a first valve element disposed at least partially within the valve housing. The first valve element may have a first passage extending therethrough. Additionally, the valve may include one or more additional valve elements for restricting fluid flow through the first passage. The one or more additional valve elements may be moveable between different positions, and the one or more additional valve elements may restrict fluid flow through the second passage by different amounts when in different positions. The valve may also include valve controls. The valve controls may be configured to adjust fluid flow between the ports at least partially by moving the first valve element. The valve controls may also be configured to adjust fluid flow through the first passage by moving one or more of the additional valve members.

### BRIEF DESCRIPTION OF THE DRAWINGS

FIG. 1A is a diagrammatic illustration of one embodiment of a fluid-control system according to the present disclosure in a first operating state;

FIG. 1B is a close-up illustration of the portion of FIG. 1A shown in circle 1B;

FIG. 2A is a diagrammatic illustration of the fluid-control system shown in FIG. 1A in a second operating state;

FIG. 2B is a close-up illustration of the portion of FIG. 2A shown in circle 2B;

FIG. 3A is a diagrammatic illustration of the fluid-control system shown in FIG. 1A in a third operating state;

FIG. 3B is a close-up illustration of the portion of FIG. 3A shown in circle 3B;

FIG. 4A is a diagrammatic illustration of the fluid-control system shown in FIG. 1A in a fourth operating state; and

FIG. 4B is a close-up illustration of the portion of FIG. 4A shown in circle 4B.

### DETAILED DESCRIPTION

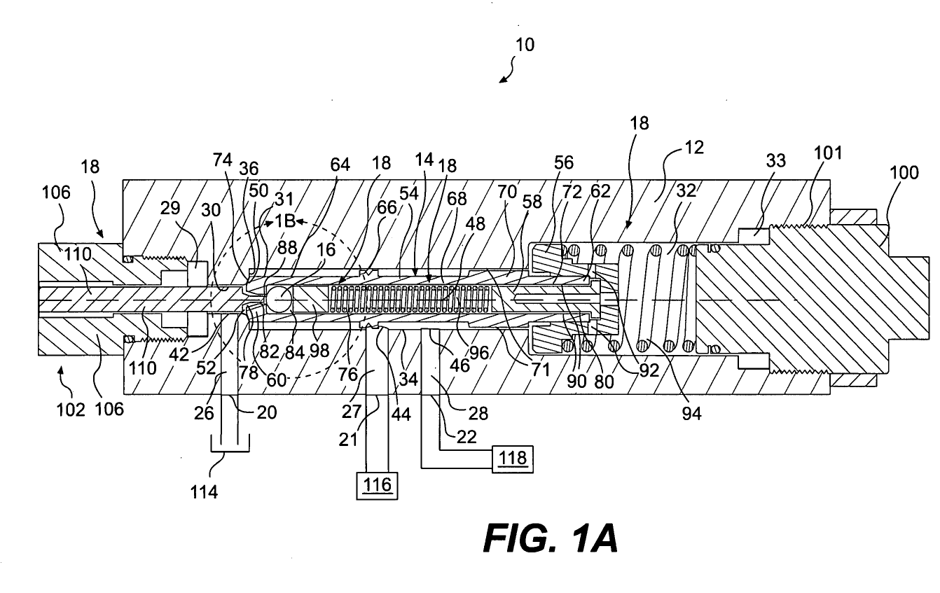

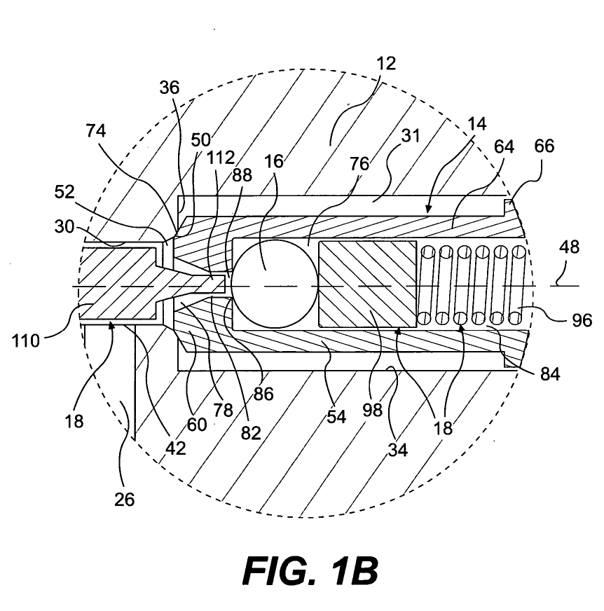

FIGS. 1A and 1B illustrate one embodiment of a fluid-control system 10 according to the present disclosure. As is shown in FIGS. 1A and 1B, fluid-control system 10 may be a valve, such as a spool valve. Fluid-control system 10 may include a valve housing 12, a first first valve element 14, a second valve element 16, and valve controls 18.

Valve housing 12 may include ports 20, 21, 22, passages 26, 27, 28, a cavity 29, a passage 30, and cavities 31, 32, 33. Cavity 31 may extend along an axis 48. As is shown in FIG. 1A, cavity 31 may have a substantially constant cross-section along axis 48. Passage 30 may extend from an opening 52 in an end wall 36 of cavity 31 to cavity 29. As is best shown in FIG. 1B, valve housing 12 may include a sealing surface 50 extending circumferentially around opening 52. Sealing surface 50 may taper outward as it extends toward cavity 31. Passage 26 may extend between port 20 and an opening 42 in the surface of passage 30. Similarly, passages 27, 28 may extend between ports 21, 22 and openings 44, 46 in a side wall 34 of cavity 31.

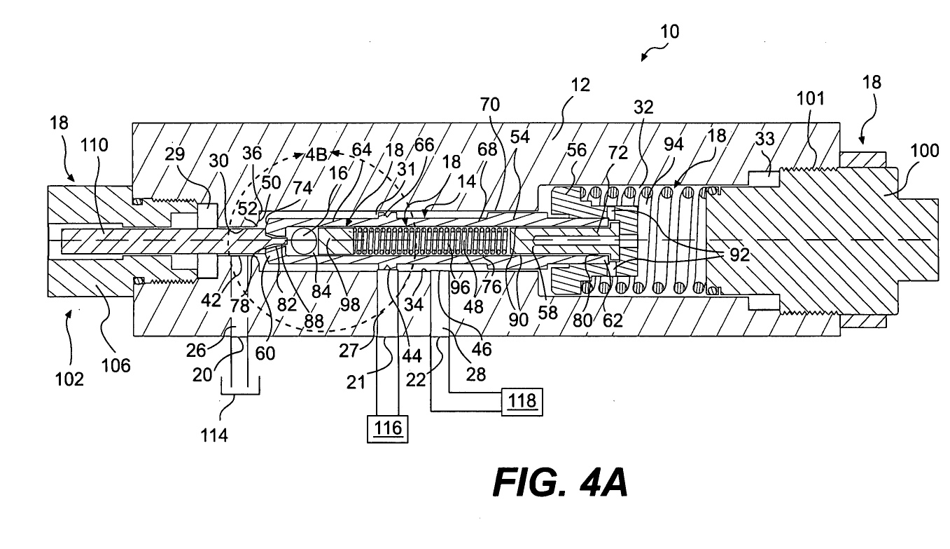

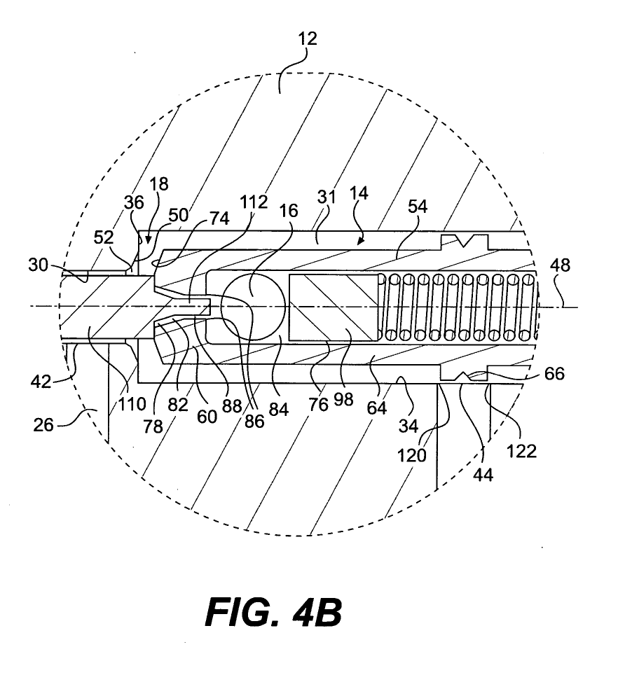

First valve element 14 may include a valve member 54, a cap 56, and an insert 58. As is shown in FIGS. 1A and 1B, first valve element 14 may be a spool valve element. Valve member 54 may extend from an end 60 disposed in cavity 31, along axis 48, to an end 62 disposed in cavity 32. Between its ends 60, 62, valve member 54 may include portions 64, 66, 68, 70, 72. Lands 66, 70 may be configured to engage side wall 34 of cavity 31 in such a manner to guide valve member 54 along axis 48. Lands 66, 70 may be configured to fit closely inside side wall 34 of cavity 31, such that fluid in cavity 31 is substantially prevented from flowing past lands 66, 70 along axis 48. As is best seen in FIG. 4B, in some embodiments, land 66 may be slightly narrower than opening 44. Alternatively, in some embodiments, land 66 may be substantially the same width as opening 44, or slightly wider than opening 44. In contrast to lands 66, 70, portions 64, 68 of valve member 54 may have cross-sections significantly smaller than cavity 31, such that fluid may easily flow axially in the spaces between side wall 34 and portions 64, 68. As is best shown in FIG. 1B, valve member 54 may also include a sealing surface 74 configured to mate with sealing surface 50. Sealing surface 74 may be a circumferentially extending tapered surface on end 60 of valve member 54.

A passage 76 may extend through valve member 54. Passage 76 may extend from an end 78, along axis 48, to an end 80. As is best shown in FIG. 1B, sealing surface 74 may extend around end 78 of passage 76. The cross-section of passage 76 may change as it extends between ends 78, 80. For example, a portion 82 of passage 76 adjacent end 78 may be narrower than a portion 84 of passage 76 extending from portion 82 to end 80. As is best shown in FIG. 1B, valve member 54 may include a sealing surface 86 extending around an opening 88 between portions 82, 84 of passage 76.

Cap 56 and insert 58 may be mounted to valve member 54 at end 62. Insert 58 may be disposed inside passage 78 at end 80 thereof. Cap 56 may be fixedly attached over portion 72 of valve member 54, such as by an interference fit between portion 72 of valve member 54 and an inner surface of cap 56. Cap 56 and insert 58 may be configured to provide fluid communication between passage 76 and cavity 32 in valve housing 12. Insert 58 may be shaped to leave spaces 90 through which fluid may flow through passage 76 past insert 58. Additionally, cap 56 may have passages 92 that provide fluid communication between spaces 90 and cavity 32.

Second valve element 16 may be configured to selectively block passage 76. Second valve element 16 may be any type of device moveably disposed inside passage 76 and configured to block opening 88 by seating against sealing surface 86. For example, as is shown in FIGS. 1A and 1B, second valve element 16 may be a ball.

Valve controls 18 may be configured to control the positions of valve elements 14, 16. Valve controls 18 may include springs 94, 96, a member 98, an adjuster 100, and a controllable actuator 102. Adjuster 100 may be disposed inside cavities 32, 33 and secured to valve housing 12, such as by engagement to threads 101 in a side wall of cavity 33. Spring 94 may be compressed between adjuster 100 and cap 56 of first valve element 14 such that spring 94 urges first valve element 14 away from adjuster 100 toward end wall 36 of cavity 31. As a result, when unopposed by controllable actuator 102, spring 94 may cause sealing surface 74 of valve member 54 to abut sealing surface 50 of valve housing 12, as is shown in FIGS. 1A and 1B.

Spring 96 and member 98 may control the position of second valve element 16 within passage 76. Member 98 may be disposed on a side of second valve element 16 opposite sealing surface 86. Spring 96 may be compressed between insert 58 and member 98, such that spring 96 urges member 98 and second valve element 16 away from insert 58, causing second valve element 16 to abut sealing surface 86 and block opening 88.

Controllable actuator 102 may include an actuator body 106 and a drive member 110. Controllable actuator 102 may be any type of device configured to provide controlled movement of drive member 110. For example, controllable actuator 102 may be an electric solenoid. Actuator body 106 may be disposed partially within cavity 29 and fixedly engaged to valve housing 12, such as by threaded engagement with a side wall of cavity 29. From actuator body 106, drive member 110 may extend along axis 48, through opening 52, into cavity 31. As is best shown in FIG. 1B, an end portion 112 of drive member 110 may extend into portion 82 of passage 76.

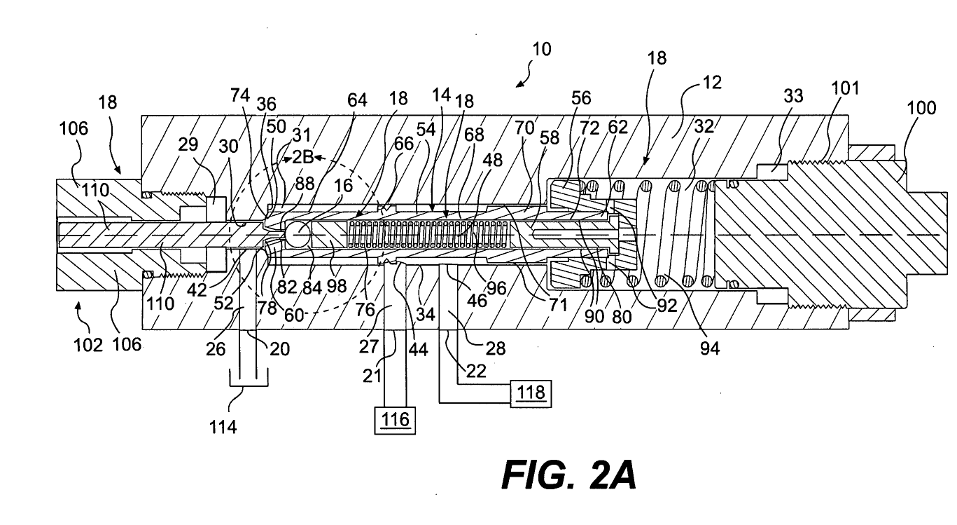

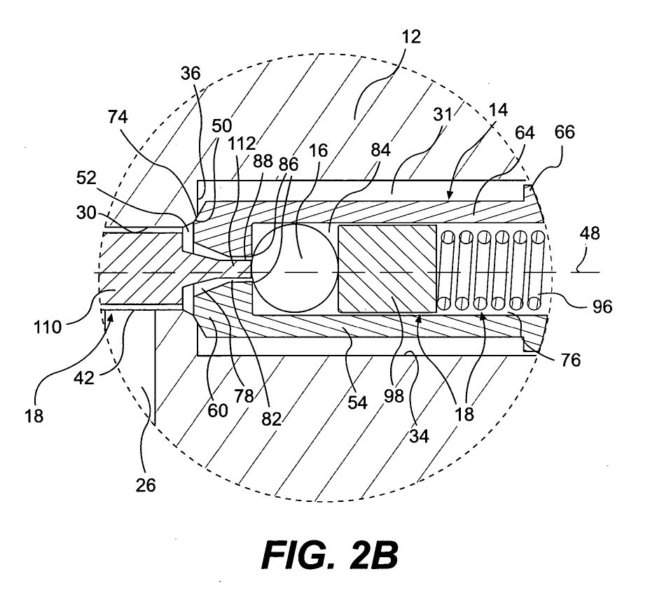

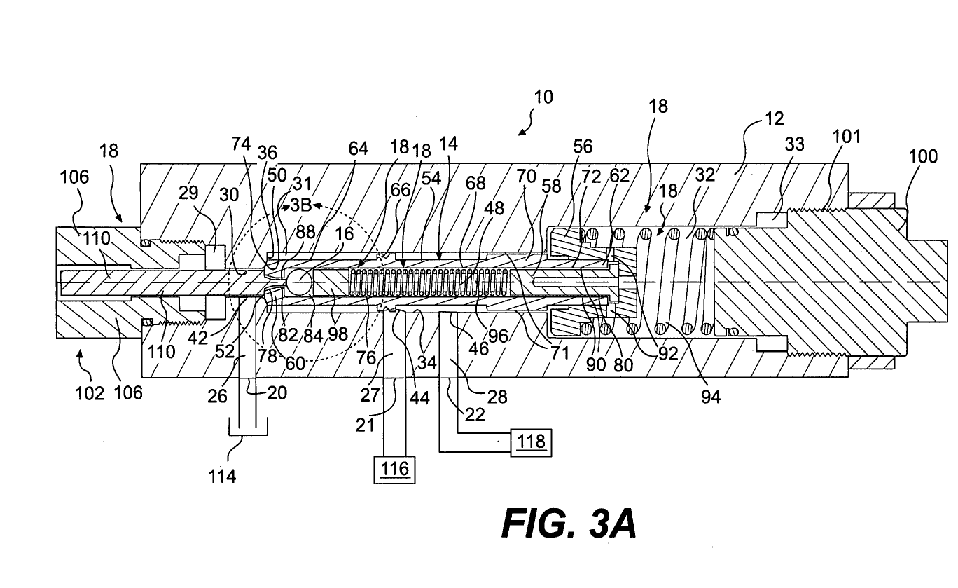

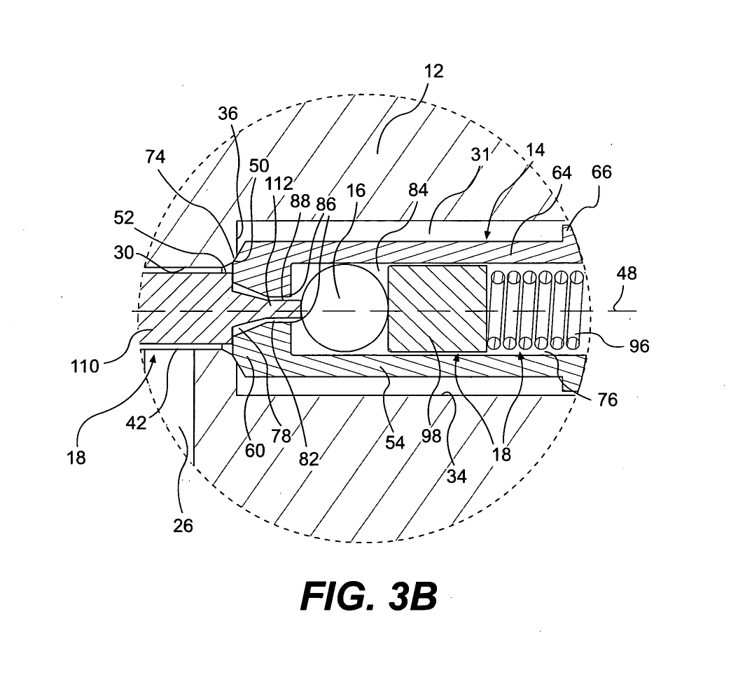

Controllable actuator 102 may be operable to move valve elements 14, 16 from the positions shown in FIGS. 1A and 1B and, thereby, unblock passage 30 by moving drive member 110 from the position shown in FIGS. 1A and 1B further into cavity 31. FIGS. 2A and 2B, FIGS. 3A and 3B, and FIGS. 4A and 4B show various stages in such a process of operating controllable actuator 102. Drive member 110 may be configured such that, initially, moving drive member 110 further into cavity 31 causes end portion 112 of drive member 110 to extend further into passage 76 and drivingly engage second valve element 16 without drivingly engaging valve member 54, as is shown in FIGS. 2A and 2B. Additionally, drive member 110 may be configured such that subsequently moving drive member 110 further into cavity 31 causes end portion 112 to drive second valve element 16 away from sealing surface 86, until drive member 110 drivingly engages valve member 54, as is shown in FIGS. 3A and 3B. After drive member 110 drivingly engages valve member 54, controllable actuator 102 may move end 60 of valve member 54 away from opening 52 to the position shown in FIGS. 4A and 4B.

Furthermore, drive member 110 may have means for allowing fluid communication between end 78 of passage 76 and passage 30 when drive member 110 is in the position shown in FIGS. 3A and 3B. For example, drive member 110 may include radially-extending passages in the portion of drive member 110 that engages valve member 54.

Fluid-control system 10 is not limited to configurations shown in the figures. For example, valve housing 12 may include additional ports and/or omit one or more of ports 20-22. Additionally, valve housing 12 may have different numbers and/or configurations of passages and cavities than shown in the figures. For example, the lengths and cross-sections of passages 26-28, cavity 29, passage 30, and cavities 31-33 may differ substantially from the configuration shown in the figures. Additionally, while the figures show cavity 31 having a well-defined end wall 36 marking the end of cavity 31 and the beginning of passage 30, cavity 31 may transition gradually into passage 30. Moreover, fluid-control system 10 may include additional components that cooperate with valve member 54 to block passage 30. Additionally, in place of second valve element 16, fluid-control system 10 may include multiple valve elements configured to selectively block passage 76. Furthermore, in place of one or more valve elements disposed inside passage 76, fluid control-system 10 may include one or more valve elements disposed outside passage 76, such as adjacent end 78 or end 80, and configured to selectively block passage 76.

Additionally, valve controls 18 may differ from the configurations shown in the figures. For example, valve controls 18 may include different numbers and/or configurations of actuators for moving valve elements of fluid-control system 10. Valve controls 18 may include actuators configured to move valve elements of fluid-control system 10 through means other than mechanical engagement, such as moving magnetic fields. Furthermore, rather than a powered actuator, valve controls 18 may include one or more manually operated actuators.

### INDUSTRIAL APPLICABILITY

Fluid-control system 10 may have application in any system requiring control of fluid flow through one or more passages. For example, as is shown in FIGS. 1A, 2A, 3A, and 4A, fluid-control system 10 may be implemented to control the flow of fluid between a low pressure fluid source 114 connected to port 20, a fluid-actuated device 116 connected to port 21, and a high-pressure fluid source 118 connected to port 22. Low-pressure fluid source/sink 114 may be various types of devices, including, but not limited to, a reservoir and a hydraulic actuator. Fluid-actuated device 116 may be any type of device configured to receive and/or supply fluid. High-pressure fluid source 118 may be any type of device configured to provide fluid at a relatively high pressure, including, but not limited to, a pump and a fluid-operated actuator under a load.

Fluid-control system 10 may be operated to control fluid flow between ports 20-22 by utilizing valve controls 18 to control the positions of valve elements 14, 16. When valve controls 18 cause valve elements 14, 16 to have the positions shown in FIGS. 1A and 1B, valve elements 14, 16 allow fluid communication between ports 21, 22. Additionally, in the positions shown in FIGS. 1A and 1B, valve elements 14, 16 block passage 30 and, thereby, prevent fluid communication between passage 30 and cavity 31. Blocking passage 30 may provide a variety of benefits in different applications of fluid-control system 10. In the application shown in the figures, blocking passage 30 prevents fluid communication between port 20 and ports 21, 22. This prevents fluid from fluid-actuated device 116 from leaking to low-pressure fluid source/sink 114, which may prevent unintentional changes in the operating state of fluid-actuated device 116.

With valve elements 14, 16 blocking passage 30, low-pressure fluid source/sink 114 connected to port 20, and high-pressure fluid source 118 connected to port 22, all but one portion of first valve element 14 may be exposed to high fluid pressure. High-pressure fluid source 118 may cause high fluid pressure in passage 28 and the portion of cavity 31 between lands 66, 70. Additionally, with passage 30 blocked, the high pressure from high-pressure fluid source 118 may be transmitted through spaces between metering land 66 and side wall 34 to the portion of cavity 31 disposed between metering land 66 and end wall 36. Similarly, the high pressure from high-pressure fluid source 118 may transmit through spaces between land 70 and side wall 34 to cavity 32 and, from there, through passages 92 and spaces 90 into passage 76. However, with valve elements 14, 16 blocking passage 30, the portion of valve member 54 inside of sealing surface 74 may be exposed to the low pressure of low-pressure fluid source/sink 114.

This distribution of fluid pressures on first valve element 14 may cause an unbalanced fluid force on first valve element 14 that presses sealing surface 74 of valve member 54 against sealing surface 50. The high pressure fluid between lands 66 and 70 may exert approximately equal and opposite forces on lands 66, 70. The high pressure fluid in cavity 32 may exert a net force on first valve element 14 that urges sealing surface 74 of first valve element 14 toward sealing surface 50. In opposition to this force, the fluid in passage 30 and the fluid in the portion of cavity 31 to the left of metering land 66 may exert forces on first valve element 14 urging sealing surface 74 away from sealing surface 50. However, because of the low pressure of the fluid in passage 30, the force of the fluid in cavity 32 urging sealing surface 74 against sealing surface 50 may be significantly greater than the fluid forces urging sealing surface 74 away from sealing surface 50. In some circumstances, the pressure differential between the fluid in passage 30 and the fluid in cavity 32 may high enough that the forces pressing sealing surface 74 against sealing surface 50, including the unbalanced fluid forces and the force applied by spring 94, may be greater than the force capacity of controllable actuator 102.

The disclosed embodiments may help ensure that controllable actuator 102 is capable of moving sealing surface 74 away from sealing surface 50 even if the forces pressing first valve element 14 against sealing surface 50 are initially high. Operating controllable actuator 102 to move valve member 16 from the position shown in FIGS. 1A and 1B to the position shown in FIGS. 3A and 3B unblocks passage 76. Additionally, with drive member 110 in the position shown in FIGS. 3A and 3B, fluid communication may be allowed between end 78 of passage 76 and passage 30, such as through radially extending passages (not shown) in the portion of drive member 110 engaging valve member 54. As a result, fluid communication is allowed between passage 30 and cavity 32 through passage 76. This allows the pressure in cavity 32 to equalize with the pressure in passage 30, which significantly reduces the unbalanced forces pressing sealing surface 74 against sealing surface 50. With these forces reduced, controllable actuator 102 may more easily move first valve element 14 away from sealing surface 50, such as to the position in FIGS. 4A and 4B.

Once first valve element 14 is separated from sealing surface 50, the fluid forces on first valve element 14 may be substantially balanced. With passage 76 unblocked, fluid communication through passage 76 substantially equalizes the fluid pressure between cavity 32 and the portion of cavity 31 to the left of metering land 66 of valve member 54. As a result, the fluid in the portion of cavity 31 to the left of metering land 66 of valve member 54 and the fluid in cavity 32 may exert substantially equal and opposite forces on first valve element 14. Additionally, the fluid in the portion of cavity 31 between lands 66, 70 of valve member 54 may apply opposite and substantially equal forces to lands 66, 70 respectively.

Substantially balancing the fluid forces on first valve element 14 may promote precise, predictable control of the position of first valve element 14 by valve controls 18. With the fluid forces on first valve element 14 substantially balanced, spring 94 and controllable actuator 102 are the sources of the only substantial steady state forces acting on first valve element 14 in the directions of axis 48. This provides a well-defined, repeatable relationship between the force that control actuator 102 applies to first valve element 14 and the position of first valve element 14.

With passage 30 unblocked, the position of metering land 66 of valve member 54 with respect to opening 44 in side wall 34 affects the flow of fluid between ports 20-22. When first valve element 14 is in the position shown in FIGS. 4A and 4B, metering land 66 may allow fluid flow between ports 20, 21 and also between ports 21, 22. With first valve element 14 in the position shown in FIG. 4B, portions 120, 122 of opening 44 are left exposed on opposite sides of metering land 66.

Fluid may flow between port 21 and port 22 through portion 122 of opening 44. In the application shown in the figures, high pressure fluid from high pressure fluid source 118 may flow from port 22 to passage 27 through portion 122 of opening 44. In such circumstances, the fluid may experience a pressure drop as it flows through portion 122 of opening 44, which may cause the fluid pressure in passage 27 to be lower than the pressure at which high-pressure fluid source 118 provides fluid.

Additionally, fluid may flow between port 20 and port 21 through portion 120 of opening 44. In the application shown in the figures, the pressure of the fluid in passage 27 may be significantly higher than the pressure at port 20. As a result, fluid may flow from passage 27, through portion 120 of opening 44, into the portion of cavity 31 to the left of metering land 66 and, from there, through passage 30 and passage 26 to port 20.

Valve controls 18 may adjust the flow between ports 20-22 by moving first valve element 14 along axis 48 and thereby changing the sizes of exposed portions 120, 122 of opening 44. Moving first valve element 14 to the right of the position shown in FIG. 4B decreases the size of portion 122 of opening 44 and increases the restriction that metering land 66 presents to fluid flowing through portion 122 of opening 44. This may increase the pressure differential between passage 27 and the portion of cavity 31 between lands 66, 70. Valve controls 18 may substantially prevent fluid flow between passage 27 and the portion of cavity 31 between lands 66, 70 by moving valve element to the right far enough to eliminate exposed portion 122 of opening 44. Additionally, moving first valve element 14 to the right increases the size of portion 120 of opening 44 and decreases the restriction that metering land 66 presents to fluid flowing through portion 120. This may decrease the pressure differential between passage 27 and the portion of cavity 31 to the left of metering land 66. Moving first valve element 14 to the left of the position shown in FIG. 4B may have the opposite effect on the fluid flow between passage 27 and the portions of cavity 31 on opposite sides of metering land 66.

Application of fluid-control system 10 is not limited to that shown in the figures. For example, devices other than low-pressure fluid source/sink 114, fluid-actuated device 116, and high-pressure fluid source 118 may be connected to ports 20, 21, 22, respectively.

It will be apparent to those skilled in the art that various modifications and variations can be made in the disclosed fluid-control system without departing from the scope of the disclosure. Other embodiments of the disclosed fluid-control system will be apparent to those skilled in the art from consideration of the specification and practice of the fluid-control system disclosed herein. It is intended that the specification and examples be considered as exemplary only, with a true scope of the disclosure being indicated by the following claims and their equivalents.

What is claimed is:

1. A spool valve, including:
a valve housing, including
a cavity,
a first passage extending from an end of the cavity,
a plurality of ports connected to the cavity;
one or more components blocking the first passage, including a spool valve element disposed in a first position at least partially within the cavity; and
wherein the spool valve element is moveable to one or more other positions wherein the spool valve element leaves the first passage unblocked.

2. The spool valve of claim 1, wherein when the spool valve element is disposed in the first position, a sealing surface of the spool valve element abuts a sealing surface extending around the first passage.

3. The spool valve of claim 2, wherein at least one of the sealing surface of the spool valve element and the sealing surface extending around the first passage is a circumferentially extending tapered sealing surface.

4. The spool valve of claim 1, wherein:
the plurality of ports includes a first port and a second port;
the spool valve element is configured to allow fluid communication between the first port and the second port when the spool valve element is disposed in the first position; and
the one or more other positions of the spool valve element include a second position wherein the spool valve element substantially prevents fluid communication between the first and second ports.

5. The spool valve of claim 1, wherein:
the spool valve element includes a second passage extending therethrough; and
the second passage is configured such that, when the spool valve element is disposed in the first position and the second passage is unblocked, the second passage provides fluid communication between the first passage and the cavity;
the one or more valve elements blocking the first passage include one or more additional valve elements blocking the second passage.

6. The spool valve of claim 5, further including valve controls operable to selectively unblock the second passage by moving the one or more additional valve elements.

7. The spool valve of claim 5, further including valve controls operable to selectively unblock the first passage by
moving one or more of the additional valve members to unblock the second passage, and
subsequently, moving the spool valve element.

8. The spool valve of claim 1, wherein:
the spool valve element includes a second passage extending therethrough, a first end of the second passage being disposed adjacent the first passage;
the one or more valve elements blocking the first passage further include one or more additional valve elements disposed inside the second passage, the one or more additional valve elements blocking the second passage;
the spool valve further includes a drive member configured such that, when it is moved through a first range of positions, the drive member moves the one or more additional valve elements and, thereby, unblocks the second passage, without moving the spool valve element; and
the drive member is further configured such that, when it is moved through a second range of positions, the drive member moves the spool valve element.

9. The spool valve of claim 1, further including a drive member for moving the spool valve element, wherein the drive member extends through the passage.

10. The spool valve of claim 1, wherein:
the plurality of ports includes
a first port connected to the cavity by a second passage, and
a second port connected to the cavity by a third passage; and
the first valve member is configured to restrict fluid flow between the first and second ports by different amounts when the first valve member is in different positions within the cavity.

11. The spool valve of claim 1, wherein:
the spool valve element is configured to slide along an axis within the cavity;
the plurality of ports includes
a first port connected to the cavity through a first opening in a side wall of the cavity, and
a second port connected to the cavity through a second opening in a side wall of the cavity; and
the spool valve element is configured to restrict fluid flow between the first and second openings by different amounts when the first valve member is in different positions along the axis.

12. The spool valve of claim 1, wherein:
the spool valve element includes a land portion having a close fit with a side wall of the cavity;
the valve housing includes a space disposed on a side of the land portion opposite the first passage; and
the spool valve further includes a second passage capable of allowing fluid flow between the first passage and the space when the spool valve element is in a position wherein the spool valve element leaves the first passage unblocked.

13. The spool valve of claim 12, wherein the spool valve further includes one or more additional valve elements configured to selectively block the second passage.

14. The spool valve of claim 13, further including valve controls operable to selectively move one or more of the additional valve elements to selectively unblock the second passage.

15. The spool valve of claim 13, wherein the second passage extends through the spool valve element.

16. The spool valve of claim 12, wherein the second passage extends through the spool valve element.

17. A fluid-control system, comprising:
a structure having a first passage between a first space and a second space;
a plurality of components blocking the first passage, including
a first valve element, wherein a second passage extends through the first valve element, the second passage being configured to provide fluid communication between the first passage and the second space when the second passage is unblocked, and
one or more additional valve elements blocking the second passage, and
valve controls operable to selectively unblock the first passage by
moving one or more of the additional valve elements to unblock the second passage, and
subsequently, moving the first valve element.

18. The fluid-control system of claim 17, wherein:
the valve controls include a moveable drive member for moving the first valve element and one or more of the additional valve elements; and
the drive member is configured such that, as the drive member is moved to move the first valve element and one or more of the additional valve elements, a portion of the drive member extends into the second passage and moves one or more of the additional valve elements before the drive member engages and moves the first valve element.

19. The fluid-control system of claim 17, wherein:
the structure is a valve housing having a plurality of ports; and
the valve housing and the first valve element are configured and associated with one another in a manner allowing adjustment of fluid flow between the ports of the valve housing by adjusting the position of the first valve element.

20. The fluid-control system of claim 17, wherein:
the structure is a valve housing having a first port, a second port, and a third port;
the first valve element is in a first position when the plurality of valve elements are blocking the first passage;
with the first valve element in the first position, fluid communication between the first port and the second port is substantially prevented, and fluid communication between the second port and the third port is allowed;
the valve controls are operable to move the first valve element to a second position; and
when the first valve element is disposed in the second position, fluid communication is allowed between the first port and the second port, and fluid communication is substantially prevented between the second port and the third port.

21. The fluid-control system of claim 17, wherein the first valve element has a sealing surface that abuts a sealing surface of the structure.

22. The fluid-control system of claim 21, wherein the sealing surface of the structure extends circumferentially around the opening.

23. The fluid-control system of claim 21, wherein at least one of the sealing surface of the first valve element and the sealing surface of the structure is a circumferentially extending tapered sealing surface.

24. The fluid-control system of claim 21, wherein:
the structure is a valve housing, the valve housing including
a cavity from an end of which the first passage extends,
a first port in fluid communication with the cavity through a first opening in a side wall of the cavity, and
a second port in fluid communication with the cavity through a second opening in a side wall of the cavity;
the first valve element is disposed at least partially within the cavity and configured to slide along an axis; and
the first valve element is configured to restrict fluid flow between the first and second openings by different amounts when the first valve member is in different positions along the axis.

25. A method of operating a fluid-control system having a structure including a first passage disposed between a first space and a second space, the method comprising:
blocking the first passage with a plurality of components, the plurality of valve elements including
a first valve element having a second passage extending therethrough, and
one or more additional valve elements blocking the second passage; and
subsequently, unblocking the first passage, including
moving one or more of the additional valve elements to unblock the second passage and, thereby, provide fluid communication between the first passage and the second space through the second passage, and
subsequently, moving the first valve element.

26. The method of claim 25, wherein:
the fluid-control system includes a drive member for moving the first valve element and one or more of the additional valve elements; and
unblocking the first passage includes causing the drive member to engage and move one or more of the additional valve elements and, subsequently, to engage and move the first valve element.

27. The method of claim 25, wherein:
the one or more additional valve elements are disposed in the second passage; and
unblocking the first passage includes causing a portion of the drive member to extend into the second passage and move one or more of the additional valve elements and, subsequently, causing the drive member to engage and move the first valve element.

28. The method of claim 25, wherein blocking the first passage includes causing a sealing surface of the first valve element to abut a sealing surface of the structure.

29. The method of claim 28, wherein at least one of the sealing surface of the first valve element and the sealing surface of the structure is a circumferentially extending tapered sealing surface.

30. The method of claim 25, wherein:
the structure is a valve housing, the valve housing having a plurality of ports; and
the method further includes adjusting the flow of fluid between the plurality of ports by adjusting the position of the first valve element.

31. The method of claim 25, wherein:
the structure is a valve housing having a first port, a second port, and a third port;
blocking the first passage includes causing the first valve element to have a first position wherein the first valve element substantially prevents fluid communication between the first port and the second port and allows fluid communication allowed between the second port and the third port; and
the method further includes selectively causing the first valve element to have a second position wherein the first valve element allows fluid communication between the first port and the second port and substantially prevents fluid communication between the second port and third port.

32. A valve, comprising:
a valve housing having a plurality of ports;
a first valve element disposed at least partially within the valve housing, the first valve element having a first passage extending therethough;
one or more additional valve elements for restricting fluid flow through the first passage, the one or more additional valve elements being moveable between different positions, wherein the one or more additional valve elements restrict fluid flow through the first passage by different amounts when in different positions; and
valve controls, wherein the valve controls are configured to adjust fluid flow between the ports at least partially by moving the first valve element, and the valve controls are further configured to adjust fluid flow through the first passage by moving one or more of the additional valve members.

33. The valve of claim 32, wherein:
the first valve element is disposed at least partially within a cavity in the valve housing;
the valve housing includes a second passage extending from the cavity;
the valve controls are operable to selectively cause the second passage to be blocked, including
blocking at least a portion of the second passage with a portion of the first valve element that includes an end of the first passage,
blocking the first passage with the one or more additional valve elements; and
the valve controls are operable to selectively unblock the second passage, including
moving one or more of the additional valve elements to unblock the first passage and, thereby, provide fluid communication between the cavity and the second passage through the first passage, and
subsequently, moving the first valve element.

34. The valve of claim 33, wherein the valve is a spool valve, and the first valve element is a spool valve element.

35. The valve of claim 32, wherein:
the first valve element is configured to slide along an axis;
the first valve element includes a first sealing surface that extends around the end of the first passage; and
the valve includes a second sealing surface that extends around the second passage;
the valve controls are configured to cause the portion of the first valve element that includes the end of the first passage to block at least a portion of the opening by pressing the first sealing surface against the second sealing surface.

36. The valve of claim 35, wherein at least one of the first sealing surface and the second sealing surface is a tapered circumferentially extending sealing surface.

37. The valve of claim 32, wherein:
one or more of the additional valve elements are disposed inside the first passage;
the valve controls include a controllable actuator having a drive member;
the controllable actuator is operable move the drive member through a first range of positions within which the drive member drivingly engages and moves one or more of the additional valve elements disposed inside the passage, but does not drivingly engage the first valve element; and
the controllable actuator is configured to move the first valve element through a second range of positions within which the drive member drivingly engages and moves the first valve element.

38. The valve of claim 32, wherein the valve is a spool valve, and the first valve element is a spool valve element.
